(19) United States
(12) Patent Application Publication
(10) Pub. No.: US 2026/0319799 A1
(43) Pub. Date: Oct. 15, 2026

(54) NO-OPERATION-COMPATIBLE INSTRUCTION

(71) Applicant: Arm Limited, Cambridge (GB)

(72) Inventors: John Michael Horley, Cambridge (GB); Mark Salling Rutland, Cambridge (GB); Simon John Craske, Cambridge (GB); Madhusudana Reddy Vangireddy, Bangalore (IN)

(73) Assignee: Arm Limited, Cambridge (GB)

(21) Appl. No.: 19/100,427

(22) PCT Filed: Jun. 27, 2023
(86) PCT No.: PCT/GB2023/051674

§ 371 Date: Jan. 31, 2025

(30) Foreign Application Priority Data
Aug. 5, 2022 (IN) 202211044855

(51) Int. Cl. G06F 9/30

(52) U.S. Cl. CPC G06F 9/3016; G06F 9/30076

(57) ABSTRACT

An apparatus comprises an instruction decoder to decode instructions; processing circuitry to perform data processing in response to decoding of the instructions by the instruction decoder; and at least one control register to specify instruction-function-selecting information. In response to a no-operation-compatible instruction, the instruction decoder is configured to control the processing circuitry to: treat the no-operation-compatible instruction as a no-operation instruction, when the instruction-function-selecting information specified by the at least one control register is in a first state; perform both a first operation and a second operation, when the instruction-function-selecting information specified by the at least one control register is in a second state; and perform the first operation but not the second operation, when the instruction-function-selecting information specified by the at least one control register is in a third state.

The present technique relates to the field of data processing.

A data processing apparatus has processing circuitry to perform data processing in response to instructions decoded by an instruction decoder. The format of the instruction encoding and the functionality represented by each instruction may be defined according to an instruction set architecture (ISA). The ISA represents the agreed framework between the hardware manufacturer who manufactures the processing hardware for a given processor implementation and the software developer who writes code to execute on that hardware, so that code written according to the ISA will function correctly on hardware supporting ISA. There can be a design challenge in selecting the instructions supported by the ISA and their encodings. Design decisions made by the ISA designer when planning the instruction definitions of the ISA may have a significant effect on real world performance achieved by processing hardware when executing a particular program.

At least some examples provide an apparatus comprising: an instruction decoder to decode instructions; processing circuitry to perform data processing in response to decoding of the instructions by the instruction decoder; and at least one control register to specify instruction-function-selecting information; in which: in response to a no-operation-compatible instruction, the instruction decoder is configured to control the processing circuitry to: treat the no-operation-compatible instruction as a no-operation instruction, when the instruction-function-selecting information specified by the at least one control register is in a first state; perform both a first operation and a second operation, when the instruction-function-selecting information specified by the at least one control register is in a second state; and perform the first operation but not the second operation, when the instruction-function-selecting information specified by the at least one control register is in a third state.

At least some examples provide a method comprising: decoding instructions; and performing data processing in response to decoding of the instructions; in which: in response to decoding of a no-operation-compatible instruction, the method comprises: treating the no-operation-compatible instruction as a no-operation instruction, when instruction-function-selecting information specified by at least one control register is in a first state; performing both a first operation and a second operation, when the instruction-function-selecting information specified by the at least one control register is in a second state; and performing the first operation but not the second operation, when the instruction-function-selecting information specified by the at least one control register is in a third state.

At least some examples provide a computer program comprising instructions which, when executed by a host data processing apparatus, control the host data processing apparatus to provide an instruction execution environment for executing target code, the computer program comprising: instruction decoding program logic to decode instructions of the target code; and register emulating program logic to maintain data in storage circuitry of the host data processing apparatus to emulate at least one control register for specifying instruction-function-selecting information; in which: in response to a no-operation-compatible instruction, the instruction decoding program logic is configured to control the host data processing apparatus to: treat the no-operation-compatible instruction as a no-operation instruction, when the instruction-function-selecting information is in a first state; perform both a first operation and a second operation, when the instruction-function-selecting information is in a second state; and perform the first operation but not the second operation, when the instruction-function-selecting information is in a third state.

The computer program may be stored on a storage medium. The storage medium may be a non-transitory storage medium or a transitory storage medium.

Further aspects, features and advantages of the present technique will be apparent from the following description of examples, which is to be read in conjunction with the accompanying drawings, in which:

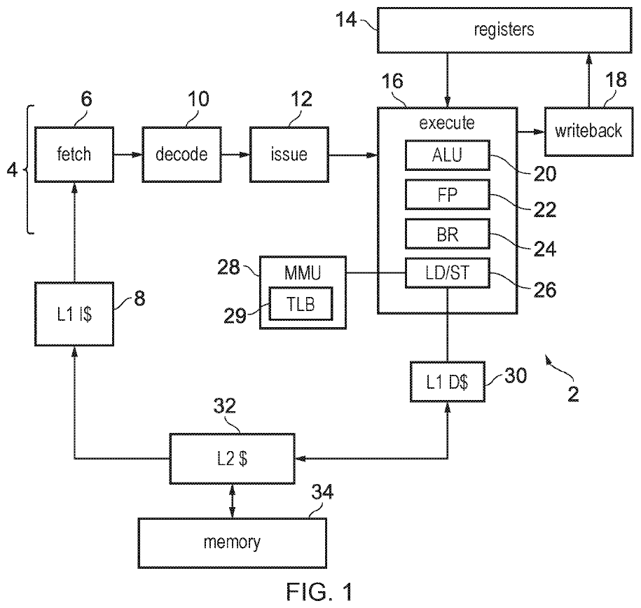

FIG. 1 schematically illustrates an example of a data processing apparatus;

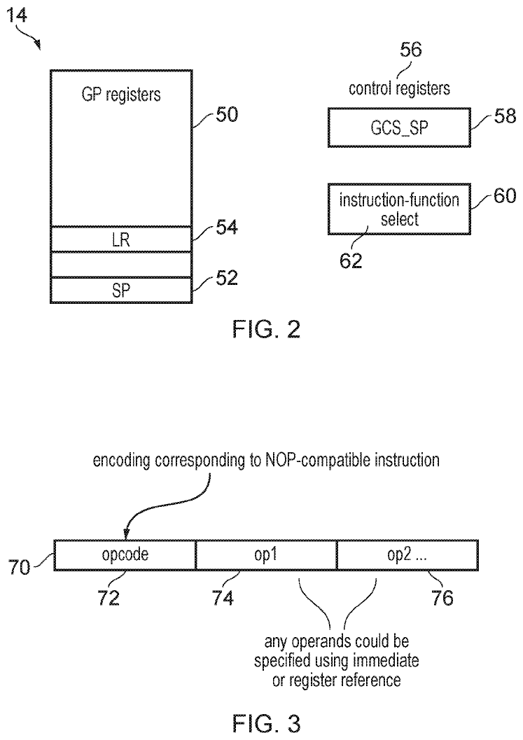

FIG. 2 illustrates an example of registers of the apparatus;

FIG. 3 illustrates an example of a no-operation-compatible (NOP-compatible) instruction;

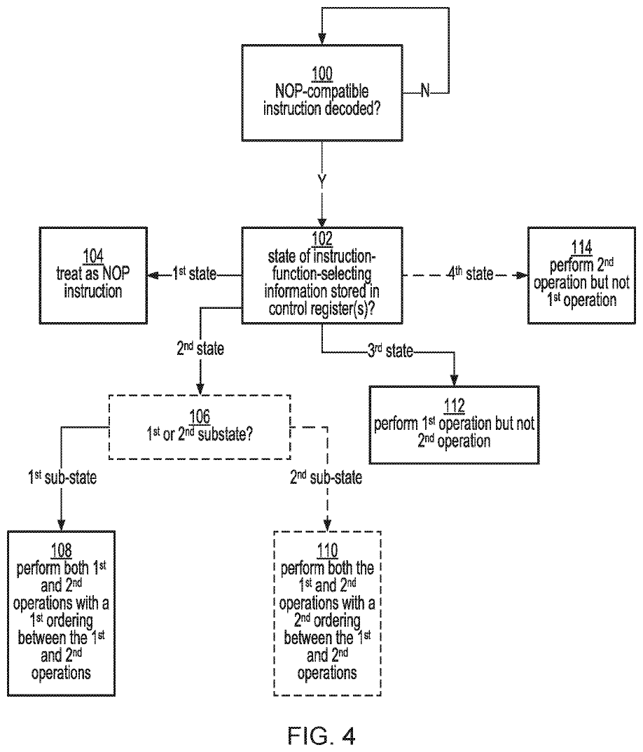

FIG. 4 illustrates a method of processing the NOP-compatible instruction;

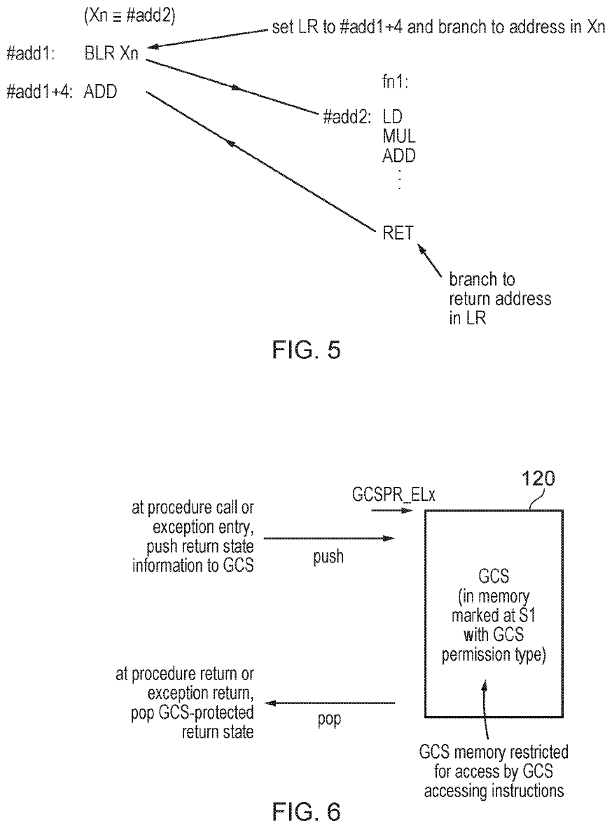

FIG. 5 illustrates an example of a function call and function return;

FIG. 6 illustrates an example of a guarded control stack (GCS) push operation and a GCS pop operation;

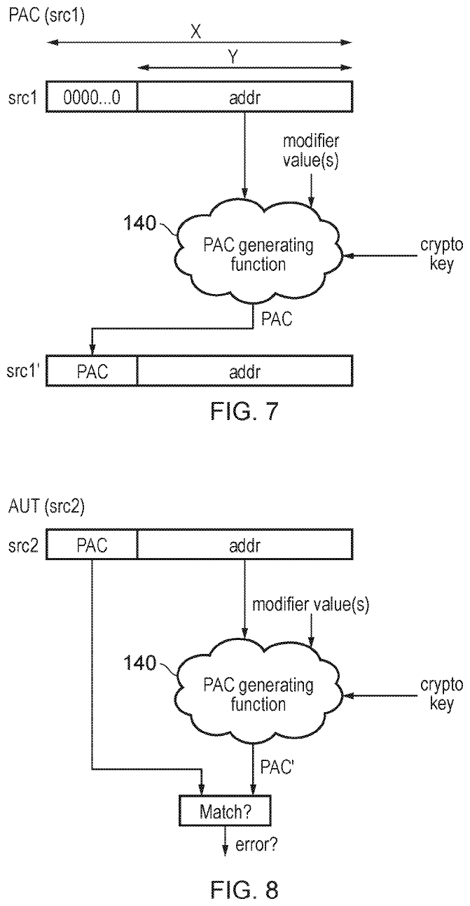

FIG. 7 illustrates an example of an authentication code generating operation;

FIG. 8 illustrates an example of an authentication code checking operation;

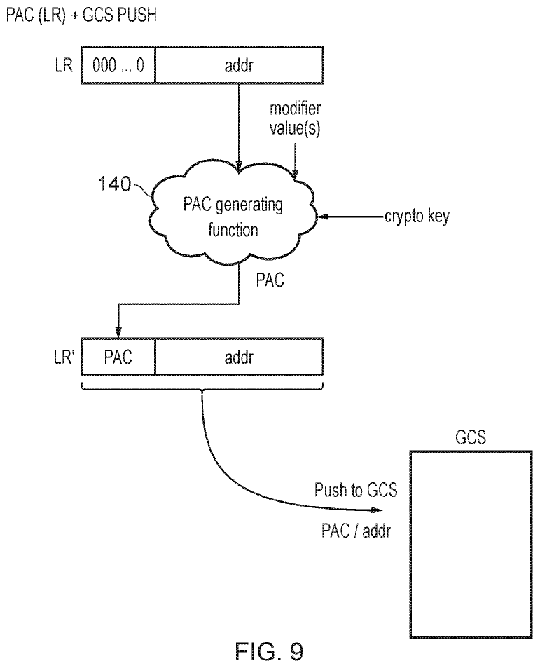

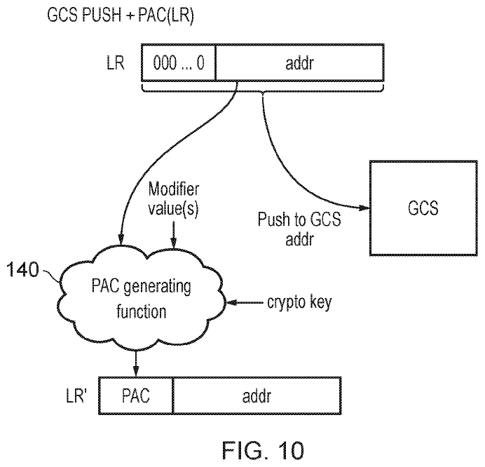

FIGS. 9 and 10 illustrate examples of executing the GCS push operation and the authentication code generating operation with different ordering;

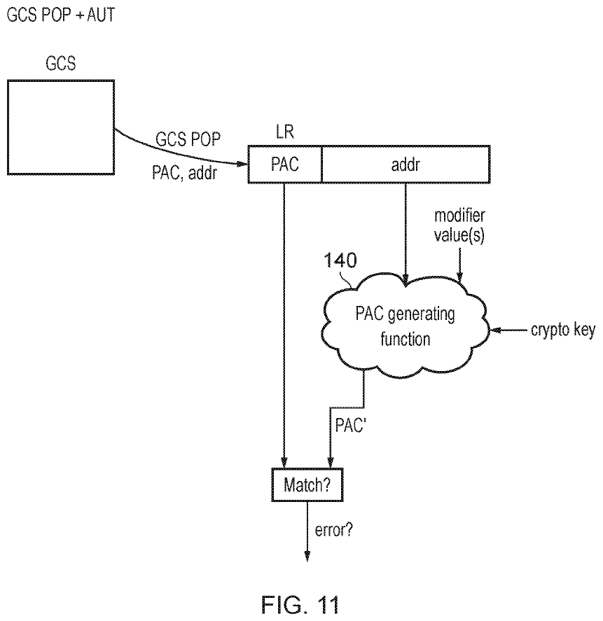

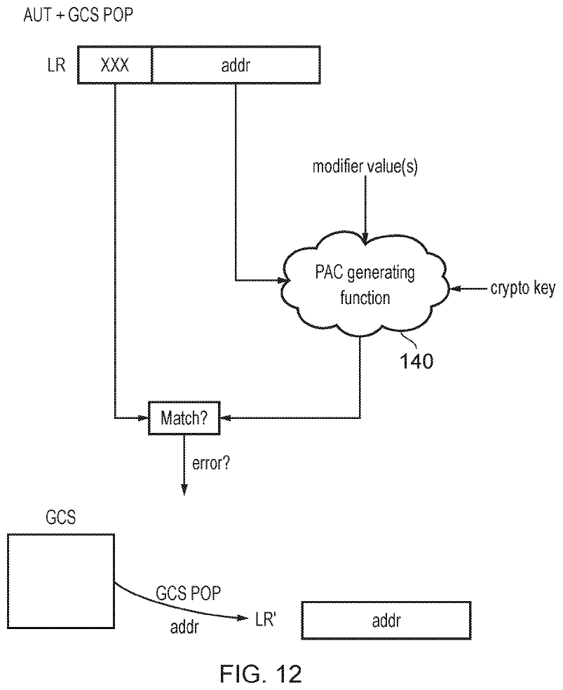

FIGS. 11 and 12 illustrate examples of executing the GCS pop operation and the authentication code checking operation with different ordering;

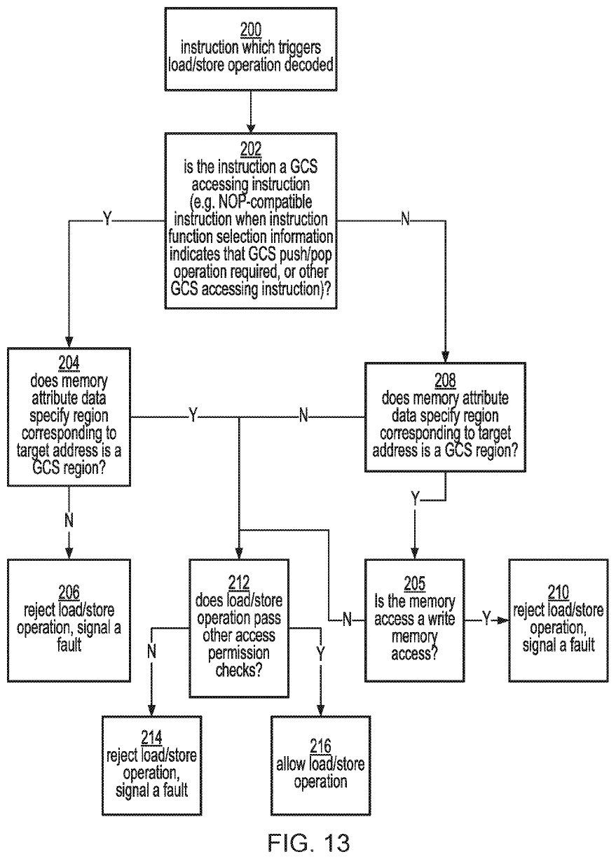

FIG. 13 illustrates steps for checking whether a memory access is permitted based on memory attribute data; and

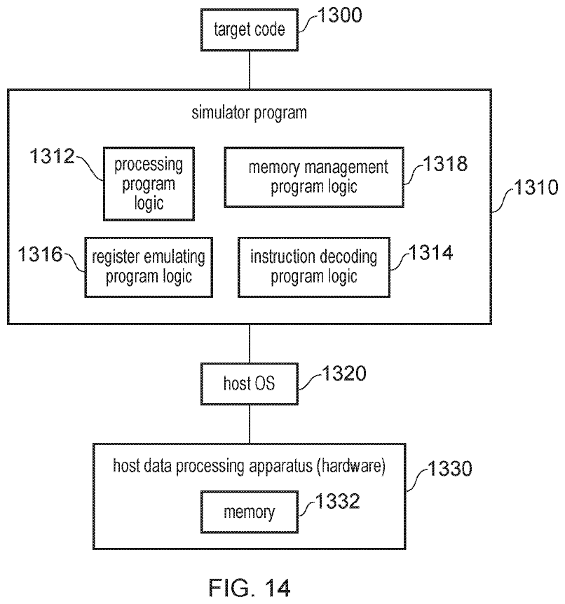

FIG. 14 illustrates a simulation example.

An apparatus comprises an instruction decoder to decode instructions; processing circuitry to perform data processing in response to decoding of the instructions by the instruction decoder; and at least one control register to specify instruction-function-selecting information. In response to a no-operation-compatible (NOP-compatible) instruction, the instruction decoder controls the processing circuitry to: treat the NOP-compatible instruction as a no-operation (NOP) instruction, when the instruction-function-selecting information specified by the at least one control register is in a first state; perform both a first operation and a second operation, when the instruction-function-selecting information specified by the at least one control register is in a second state; and perform the first operation but not the second operation, when the instruction-function-selecting information specified by the at least one control register is in a third state.

The NOP-compatible instruction can be useful for implementing some optional operations which may be useful if performed but are not critical to correct functioning of the software program which uses the instruction. For example, the first and second operations could be operations providing optional security enhancements or performance hint operations which can help to improve security and/or performance even if not essential to obtaining the correct functional results of the program. Those enhancements may not always be required and so it may be desirable to be able to control whether, on a given instance of executing a sequence of code which includes the instruction for performing one or both of the first and second operations, those operations are actually performed. Not performing the operations may help to save power or allow for analysis of how the same code would run on legacy hardware which does not support the optional operations. By controlling the instruction's functionality based on instruction-function-selecting information stored in at least one control register, the same program code can execute in different use scenarios, with different outcomes for which of first and second operations (if any) is executed by the processing circuitry in response to the instruction, depending on the current value of the instruction-function-selecting information.

When the instruction-function-selecting information is in a first state, the instruction behaves as a NOP instruction. A NOP instruction may be an instruction whose execution does not cause any change in architectural state, other than the change in program counter which may be implicit in program flow advancing sequentially (with no branch) from the NOP instruction to the next instruction after the NOP. Hence, the software developer has the option of turning off the features represented by the first and second operations altogether. This can be useful, for example, where the first and second operations correspond to features introduced in a more recent version of an ISA which may not be available on legacy apparatuses supporting older ISA versions. Another use case can be where the first and second operations may not always be needed (e.g. when code is executed for a less secure use case, a security enhancement represented by the first and/or second operation can be turned off, to save power, by setting the instruction-function-selecting information to the first state before executing the code sequence including the NOP-compatible instruction).

When the instruction-function-selecting information is in a second state, the processing circuitry performs both the first and second operations in response to the NOP-compatible instruction. When the instruction-function-selecting information is in a third state, the processing circuitry performs the first operation, but not the second operation, in response to the NOP-compatible instruction. Normally, to provide for different combinations of whether first and second operations are performed by a sequence of program code, one would expect each operation to be encoded in a separate instruction, so that executing both operations in combination would require two different instructions while if only one of the operations is required then only one of these instructions would be included in the software code. However, with the NOP-compatible instruction described above, the first and second operations can both be performed in response the same instruction (as well as having the option of the same instruction being executed with only the first operation but not the second being performed). Hence, exactly the same code binary for the portion of program code including the NOP-compatible instruction may behave in different ways depending on how the instruction-function-selecting information has been executed prior to executing that portion of program code. This provides a more efficient ISA encoding compared to an implementation which provides two separate NOP-compatible instructions corresponding to the first and second operations respectively. Firstly, this avoids the ISA needing to use up two different instruction encodings for separate NOP-compatible instructions corresponding to the first and second operations respectively, saving an encoding which can be used for another type of instruction, and hence improving performance for code making use of that other type of instruction (in comparison to requiring the operation of that other type of instruction to be split into a number of simpler instructions). Also, software code which uses the NOP-compatible instruction will only require the processing circuitry to use a single instruction slot for the instruction in the fetch, decode, issue and execute stages of a processing pipeline (as well as in an instruction cache or other storage for storing the program code being executed), which conserves an instruction slot for use by another instruction for implementing a different operation, and therefore can improve performance, as well as improving code storage density in the cache and in memory.

Therefore, the NOP-compatible instruction described above can help to improve performance and efficiency of ISA encoding for use cases where there are optional operations that may not always be required.

In some examples, the NOP-compatible instruction may not support the option of performing the second operation without performing the first operation. For example, any remaining encodings of the instruction-function-selecting information (other than the first, second and third states described above) may be used to control other features of how the first or second operations are performed (e.g. a control parameter adjusting the behaviour of the first operation or the second operation), rather than being used to indicate that the second operation should be performed without the first operation.

However, in other examples, in response to the NOP-compatible instruction, the instruction decoder may control the processing circuitry to perform the second operation but not the first operation, when the instruction-function-selecting information is in a fourth state. This can be particularly useful so that the NOP-compatible instruction can be used to perform either the first operation without the second operation, or the second operation without the first operation, or both operations together, or can behave as a NOP so that neither the first operation nor the second operation can be performed. Hence, the instruction-function-selecting information can be used to turn on and off each of the first operation and the second operation independently. This provides the same flexibility in selection of which operations are performed as would be the case if each of the first and second operations was encoded as a separate NOP-compatible instruction, but with a more efficient instruction encoding.

In some examples, when the instruction-function-selecting information is in the second state, the processing circuitry may control, based on the instruction-function-selecting information, a relative order in which the first operation and the second operation are applied. For example, the first operation could be performed before the second operation, or the second operation could be performed before the first operation, or both operations could be performed in parallel. The instruction-function-selecting information can be used to select between two or more of these options. This can be useful as one ordering between the first and second operations may have advantages over another. For example, a first ordering could provide greater security but a second ordering could be more efficient for performance. Hence, providing control state which allows configuration of the relative ordering used can be useful to allow the same code binary to execute with different use cases which may have different preferences for prioritising security and/or processing performance.

A wide range of processing operations could be implemented as the first operation and second operation respectively.

However, the NOP-compatible instruction can be particularly useful for function prologue operations associated with a function call. Hence, for a function-prologue variant of the NOP-compatible instruction, the first operation and the second operation are function prologue operations associated with a function call. For example, the function prologue operations may be preliminary operations to be performed before, during, or shortly after making a function call, prior to entering the main body of the function. As the same function may be called a large number of times during execution of a given software workload, even a relatively small performance saving achieved on a single instance of calling the function can lead to a large improvement of performance across the software workload as a whole, as that improvement is seen each time the function is called. Hence, by enabling the first and second operations associated with the function call to be performed in response to a single NOP-compatible instruction rather than needing multiple instructions, this can provide an appreciable performance improvement for the workload as a whole.

For similar reasons, the NOP-compatible instruction may be useful for function epilogue operations associated with a return from processing of a function. These may be operations performed after the completion of the main body of the function to prepare for returning to the background processing which called the function. Such epilogue operations could be performed before, during or after the return branch which actually returns the processing to the background processing. Hence, for a function-epilogue variant of the NOP-compatible instruction, the first operation and the second operation are function epilogue operations associated with a return from processing of a function.

In some examples, for at least one variant of the NOP-compatible instruction, one of the first operation and the second operation comprises an authentication code generating operation to generate an authentication code based on an operand and associate the authentication code with the operand.

Such an authentication code generating operation could be applied to any operand, but may be particularly useful where it is applied to the function return address which is set on a function call to represent an instruction address to which a subsequent return branch should return processing once the function body has completed, to provide a defence against return-oriented programming (ROP) attacks.

ROP based attacks are a common class of attacks on data processing systems. ROP attacks are attacks which attempt to cause a program to behave in an unexpected manner by corrupting the return state information used to return from a function call or an exception. Often software will save return state information to memory, e.g. to facilitate nesting of function calls or exceptions. Return state information for an outer function call or exception (of a nested set of function calls or exceptions) can be saved to memory to preserve it before it can be overwritten in registers with return state information for an inner function call or exception. ROP attacks can attempt to tamper with the return state information while it is stored in memory, before it is restored to registers and used to control a function return or exception return. A successful ROP attack can cause the function return or exception return to return program flow to an instruction other than the next instruction after the point at which the function was called or the exception was taken, which can allow the attacker to control the processing circuitry to perform arbitrary operations other than the sequence of operations intended by the programmer.

The authentication code generating operation can help protect against such ROP attacks by generating an authentication code corresponding to the operand (e.g. the function return address), so that a subsequent attempt to tamper with the operand while stored in memory can detected based on a mismatch between the tampered operand and the corresponding authentication code which may no longer correspond to the operand if the operand has been tampered with. While the authentication code generating operation can be useful for security, it is not essential and for some use cases it may be preferred to omit the authentication code generating operation for performance reasons. Therefore, it can be useful to provide a NOP-compatible instruction which enables selection of whether or not the authentication code generating operation is performed in response to the instruction, so that the same code sequence can execute in different scenarios with different outcomes for whether the authentication code generating operation is performed. Hence, it can be useful for one of the first and second operations to comprise an authentication code generating operation.

While the operand for the authentication code generating operation could be any arbitrary operand (e.g. an operand obtained from a register specified by the NOP-compatible instruction), in some examples the operand comprises a value obtained from a link register. In response to a function return branch instruction, the instruction decoder may control the processing circuitry to branch to an address specified in the link register. Hence, when the authentication code generating operation is applied to an operand in the link register, it may be common that the operand for the authentication code generating operation is a function return address. This can be useful to provide a defence against ROP attacks. In the case where the authentication code generating operation is applied to a function return address then this may be an example of a function prologue operation as discussed above, since it is often the case that this operation would be performed associated with a function call.

In the authentication code generating operation, the generated authentication code can be associated with the operand in different ways. For example, the authentication code could be stored to a particular register which has a known association with a register providing the operand. However, this may not be necessary and in some cases the authentication code can be embedded in part of the operand itself. Hence, associating the authentication code with the operand may comprise embedding the authentication code in a portion of more significant bits of the operand. This can be useful because by embedding the authentication code in the operand itself then this means that any subsequent operation to move the operand from one location to another (e.g. pushing the operand from a register onto a stack data structure in memory) also implicitly causes the authentication code to be transferred along with the operand, without requiring a separate operation to transfer the authentication code. The more significant bits of the operand may be available for representing the authentication code because it may be common that, while a processor architecture may support addresses with a certain number of bits (e.g. 64 bits), in practice, real world data processing devices may not yet have the need to provide memory storage that uses the entire 64-bit address space. Hence, although addresses may have 64 bits, in practice only a smaller number of bits may actually be used, with a number of most significant bits corresponding to zero (or some other fixed value). Hence, as there a number of upper bits which are not in practice used, these bits can be replaced with the authentication code (the authentication code can be inserted into any subset of these unused bits at the upper end of the address).

The authentication code generating operation may comprise generating the authentication code according to a cryptographic function based at least on the operand and a cryptographic key. By generating the authentication code according to a cryptographically-secure function such as QARMA-64, QARMA-128 or SHA256, for instance, based on a secret key, the authentication code can be generated in a way which makes it difficult for an attacker to predict the authentication code that corresponds to a given address.

In some examples, the authentication code may also depend on a modifier input to the cryptographic function. The modifier could, for example, be a value associated with a current point of processing, such as a current value of a stack pointer. This can help protect against reuse attacks where an attacker obtains a valid operand-authentication code pair used at one point of the program and tries to substitute that operand for a different operand used at a different point of the program.

In some examples, for at least one variant of the NOP-compatible instruction, one of the first operation and the second operation comprises a guarded-control-stack (GCS) push operation to push the operand to a GCS data structure for protecting return state information. Such a GCS push operation is another example of a defence measure against ROP attacks, but rather than relying on assigning an authentication code to protect the return state against tampering, a protected GCS data structure may be established which has at least one defence measure restricting the ability to write data in the GCS data structure, providing some additional protection relative to normal memory regions. Again, the GCS push operation can be an example of a function prologue operation as it can be useful to perform the GCS push operation on the function return address when calling a function. While such a GCS push operation can be useful for security, it has a performance cost and so some use cases with lower security demands may prefer not to perform it. Therefore, the GCS push operation is another example of an operation which could usefully be implemented using the NOP-compatible instruction so that exactly the same program code sequence including the NOP-compatible instruction can execute in different use cases with the instruction-function-selection information controlling whether the GCS push operation is actually carried out.

The NOP-compatible instruction is particularly useful for a variant of the NOP-compatible instruction for which one of the first operation and the second operation comprises an authentication code generating operation to generate an authentication code based on an operand and associate the authentication code with the operand; and the other of the first operation and the second operation comprises a guarded-control-stack (GCS) push operation to push the operand to a GCS data structure for protecting return state information. As the authentication code generating operation and GCS push operation can be seen as alternative techniques for protecting function return state against ROP attacks, they are often needed at the same point of a program (associated with a function call) and so it can be useful to combine them into a single instruction, while also providing the option of turning one or both of these operations off. Although both operations nominally protect against the same class of attack, they can have different pros and cons and so for a “defence in depth” some developers may wish to include both measures, so that it is useful to support the option of performing both operations at a function call. By using the NOP-compatible instruction, only a single instruction can be executed to perform both types of operation (in the case where the instruction-function-selecting information is in the second state).

In the case where the first and second operations are the authentication code generating operation and GCS push operation respectively (or vice versa), different orderings are possible between these operations. Some implementations may therefore allow selection of which ordering is used, depending on the instruction-function-selecting information.

In response to the NOP-compatible instruction when the instruction-function-selecting information is in a first sub-state of the second state, the processing circuitry may push both the operand and the authentication code to the GCS data structure (e.g. this may correspond to performing the authentication code generating operation first to embed the authentication code in the operand and then performing the GCS push operation on the result of the authentication code generating operation). This approach can improve security by protecting the authentication code using the GCS data structure.

In response to the NOP-compatible instruction when the instruction-function-selecting information being is in a second sub-state of the second state, the processing circuitry may push the operand without the authentication code to the GCS data structure. In this case, the authentication code generating operation and GCS push operation can be independent from each other and so can be performed in parallel or in either order. By supporting the option of performing them in parallel, this can improve performance, but it means the GCS data structure does not protect the authentication code.

In another example, for at least one variant of the NOP-compatible instruction, one of the first operation and the second operation comprises an authentication code checking operation to check whether an associated authentication code associated with an operand matches an expected authentication code generated based on the operand, and to trigger an error handling response in response to detecting a mismatch between the associated authentication code and the expected authentication code. This operation can be used to check the validity of the authentication code generated by the authentication code generating operation described above, and although it can be performed on any operand, it can often be performed as a function epilogue operation to check whether the return address is safe to use (defending against ROP attacks as mentioned above). Hence, for corresponding reasons to the authentication code generating operation, the NOP-compatible instruction can be useful for the authentication code checking operation.

In some examples, the associated authentication code for the authentication code checking operation may be obtained from a portion of more significant bits of the operand.

In a corresponding way to the authentication code generating operation, in the authentication code checking operation the expected authentication code may be generated according to a cryptographic function based at least on the operand and a cryptographic key, and in some cases also based on a modifier (such as a stack pointer).

For at least one variant of the NOP-compatible instruction, one of the first operation and the second operation may comprise a guarded-control-stack (GCS) pop operation to pop function return information from a GCS data structure for protecting the function return information. This can be used to obtain the return state information which was previously pushed to the GCS data structure by a previous GCS push operation. For similar reasons to the GCS push operation, the GCS pop operation (an example of a function epilogue operation) can be useful to implement using the NOP-compatible instruction.

Again, some variants of the NOP-compatible instruction may support both the authentication code checking operation and the GCS pop operation. Hence, one of the first operation and the second operation may comprise an authentication code checking operation to check whether an associated authentication code associated with an operand matches an expected authentication code generated based on the operand, and to trigger an error handling response in response to detecting a mismatch between the associated authentication code and the expected authentication code; and the other of the first operation and the second operation comprises a guarded-control-stack (GCS) pop operation to pop function return information from a GCS data structure for protecting the function return information. These operations are useful to be combined into the same NOP-compatible instruction as if both are required they will typically be performed at the same point in the program, as a function epilogue operation following completion of the main body of a function, before the function return is performed.

The ordering between the authentication code checking operation and the GCS pop operation can be controlled based on the instruction-function-selecting information. In response to the NOP-compatible instruction when the instruction-function-selecting information being is in a first sub-state of the second state, the processing circuitry may perform the GCS pop operation and perform the authentication code checking operation on a value popped from the GCS data structure by the GCS pop operation; and in response to the NOP-compatible instruction when the instruction-function-selecting information being in a second sub-state of the second state, the processing circuitry may perform the authentication code checking operation on a value in a given register prior to performing the GCS pop operation, and perform the GCS pop operation to pop the function return information from the GCS data structure to the given register. Again, this provides different options for trading off security against performance.

For cases where the NOP-compatible instruction implements, as one of the first/second operations, the GCS push operation or GCS pop operation, then in response to the NOP-compatible instruction, when the instruction-function-selecting information is in a state indicating that an access to the GCS data structure is to be performed in response to the NOP-compatible instruction (i.e. when one of the GCS push operation and GCS pop operation is to be performed), the processing circuitry may reject a memory access triggered by the NOP-compatible instruction in response to detecting that a memory region corresponding to a target address of the NOP-compatible instruction is specified by memory attribute data as being a memory region other than a GCS region for storing the GCS data structure. Hence, accesses to a memory region not designated as being for the GCS data structure may be rejected if the access is triggered by a GCS-accessing type of instruction. This avoids GCS-accessing types of instructions (including the NOP-compatible instruction when it is performing the GCS push operation or GCS pop operation) being misused to access regions of memory not intended for storing the GCS data structure, which can reduce the attack surface available for attackers to exploit.

Similarly, the processing circuitry may reject a write memory access triggered by a non-GCS-accessing type of instruction in response to detecting that a memory region corresponding to a target address of the non-GCS-accessing type of instruction is specified by memory attribute data as being the GCS region. By restricting the ability to write to the GCS region to GCS-accessing types of instructions (including the NOP-compatible instruction when the instruction-function-selecting information is in a state indicating that a GCS access is to be performed), other more general memory access instructions cannot tamper with the contents of the GCS data structure, providing a greater security guarantee for the protected return state information stored in the GCS data structure. Again, this reduces the attack surface available for attackers to exploit when trying to mount ROP attacks.

The instruction-function-selecting information could be represented in different ways. In some examples, the first, second and third states mentioned earlier could correspond to different (potentially arbitrarily selected) encodings of the instruction-function-selecting information. Hence, any mapping between the first, second and third states and different combinations of bit values of the instruction-function-selecting information can be used.

However, in some examples, it can be useful for the instruction-function-selecting information to comprise a first operation indicator to indicate whether or not the first operation is to be performed in response to the NOP-compatible instruction, and a second operation indicator to indicate whether or not the second operation is to be performed in response to the NOP-compatible instruction. For example, the instruction-function-selecting information may comprise a set of bits where each bit corresponds to one of the operations that can potentially be selected for performing in response to the NOP-compatible instruction, and indicates whether or not that operation is required to be performed. This encoding of the instruction-function-selecting information can be easy to understand for a software developer and simpler to decode by the hardware of the processing circuitry or the instruction decoder, as the selection of each operation depends only on a single indicator (e.g. single bit) rather than needing more complex decoding circuit logic.

In some examples, the NOP-compatible instruction may support the option of selecting from among more than two operations, based on the instruction-function-selecting information. Hence, the instruction-function-selecting information may further indicate whether the processing circuitry should perform a third operation in response to the NOP-compatible instruction. For example, where the instruction-function-selecting information comprises a set of bits, each indicating whether or not a respective operation should be performed in response to the NOP-compatible instruction, it can be relatively efficient to add support for additional operations as desired. Hence, while the examples discussed below show examples with two operations, the claims are not limited to this and could support additional operations as well.

The techniques discussed above may be implemented within a data processing apparatus which has hardware circuitry provided for implementing the processing circuitry and instruction decoder discussed above.

However, the same technique can also be implemented within a computer program which executes on a host data processing apparatus to provide an instruction execution environment for execution of target code. Such a computer program may control the host data processing apparatus to simulate the architectural environment which would be provided on a hardware apparatus which actually supports target code according to a certain instruction set architecture, even if the host data processing apparatus itself does not support that architecture. The computer program may have instruction decoding program logic and register emulating program logic which controls the host data processing apparatus to emulate the features discussed above, including support for the NOP-compatible instruction as described above. The instruction decoding program logic decodes instructions of the target code and generates instructions of the native architecture supported by the host to emulate the functions represented by the decoded instructions in the target code. The register emulating program logic maintains data in storage circuitry of the host data processing apparatus to emulate the contents of at least one control register, including the register(s) storing the instruction-function-selecting information as discussed above. Hence, when target code including the NOP-compatible instruction is executed in the instruction execution environment provided by the simulation computer program executing on the host data processing apparatus, the same functions as discussed above can be achieved even if the host data processing apparatus does not itself support the NOP-compatible instruction.

Such a simulation program can be useful, for example, when program code written for one instruction set architecture is being executed on a host processor which supports a different instruction set architecture. Also, the simulation can allow software development for a newer version of the instruction set architecture to start before processing hardware supporting that new architecture version is ready, as the execution of the software on the simulated execution environment can enable testing of the software in parallel with ongoing development of the hardware devices supporting the new architecture. The simulation program may be stored on a storage medium, which may be an non-transitory storage medium.

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 (an example of processing circuitry) includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34. A memory management unit (MMU), which is an example of memory management circuitry, 28 is provided for performing address translations between virtual addresses specified by the load/store unit 26 based on operands of data access instructions and physical addresses identifying storage locations of data in the memory system. The MMU has a translation lookaside buffer (TLB) 29 for caching address translation data from page tables stored in the memory system, where the page table entries of the page tables define the address translation mappings and access permissions which govern, for example, whether a given process executing on the pipeline is allowed to read or write data or execute instructions from a given memory region. The MMU 28 may have circuitry to request memory accesses during page table walks, when the page table structures are traversed to locate the page table entry corresponding to a required address.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline implementation, and the processor may include many other elements not illustrated for conciseness. While FIG. 1 shows a single processor core with access to memory 34, the apparatus 2 also could have one or more further processor cores sharing access to the memory 34 with each core having respective caches 8, 30, 32.

FIG. 2 illustrates an example of some of the registers 14 of the apparatus 2. It will be appreciated that FIG. 2 does not show all of the registers—the apparatus can also include other registers. A set of general purpose registers 50 is provided for storing general purpose operands and results of processing operations. Some of these general purpose registers may also have more specific functions, such as a link register (LR) for storing function return addresses, which may be addressable using one of the general purpose register identifiers (e.g. register X30). The registers also include a stack pointer (SP) register 52 for storing a stack pointer. The apparatus also has some control registers 56 for storing control information used to control the operation of the processor. For example, the control registers 56 may include a guarded control stack (GCS) stack pointer register 58 used to control access to the GCS as discussed further below with respect to FIG. 6, and at least one register providing instruction-function-selecting information 60 used to control the behaviour of an NOP-compatible instruction as discussed further below. While FIG. 2 shows the instruction-function-selecting information 60 as a single register, it is also possible for this information to be split across two or more registers.

FIG. 3 shows an example of an NOP-compatible instruction 70. The instruction encoding includes an opcode 72 which identifies the type of instruction, and one or more operand fields 74, 76 for specifying operands of the instruction. The operands 74, 76 could be specified either using immediate values or using register identifiers specifying registers 14 which store the operands, or a combination of both at least one immediate value and at least one register identifier. In some cases the instruction could also specify an additional destination field identifying a register to which the result of the instructions to be written, or alternatively one of the registers specified for one of the operand fields could also serve as a destination register. While FIG. 3 shows two operands for sake of example, other examples of the NOP-compatible instruction could have a larger or smaller number of operands.

The NOP-compatible instruction represents, within a single instruction encoding having a same opcode 72 and same definition of the operand fields 74, 76, the option of either performing no operation at all (so that the instruction behaves as an NOP instruction) or performing one or more of at least two different processing operations, including at least a first operation and a second operation. Which combination of operations is performed in response to the NOP-compatible instruction is selected (by the instruction decoder 10 and/or execute stage 16 of the processing pipeline 4) based on the instruction-function-selecting information 60 stored in the control register 56. This information can be set by instructions executed by the processor. For example a system register modifying instruction (which may be restricted to being executed in certain execution states or privilege levels) may be used to set the instruction-function-selecting information 60. Alternatively, there may a dedicated type of instruction for setting the instruction-function-selecting information, separate from system register modifying instructions for modifying other control registers 56. In use case when executing a piece of code that includes the NOP-compatible instruction, some examples may set the instruction-function-selecting information 60 using an earlier instruction of the same piece of code. In other examples, the instruction-function-selecting information 60 could be set by supervisory code which manages the execution of the program code that includes the NOP-compatible instruction (e.g. by an operating system which manages execution of an application, or a hypervisor which manages execution of an operating system).

FIG. 4 is a flow diagram illustrating a method of processing the NOP-compatible instruction. At step 100 the instruction decoding circuitry 10 determines whether an NOP-compatible instruction is decoded. If not, then the instruction decoding circuitry 10 decodes another type of instruction controls the processor to perform the operation represented by that instruction, and continues to wait for an NOP-compatible instruction to be decoded.

When an NOP-compatible instruction is decoded, then at step 102, the instruction decoder 10 checks (or controls another part of the processor, such as the execute stage 16 to check) the state of the instruction-function-selecting information 60 stored in the control registers 56.

If the instruction-function-selecting information 60 is in a first state, then at step 104 the instruction decoder 10 controls the execute stage 16 to treat the NOP-compatible instruction as an NOP instruction. Hence, in response to the NOP-compatible instruction, the processing circuitry does not cause any change in architectural state (other than advancing a program counter to point to the next sequential instruction after the NOP instruction).

If the instruction-function-selecting information 60 is in a second state, then at step 106 the processing depends on whether the instruction-function-selecting information is a first substate or a second substate of the second state. If the instruction-function-selecting information 60 is a first substate of the second state, then at step 108 the processing circuitry 16 is controlled to perform both first and second operations with a first ordering between the first and second operations. If the instruction-function-selecting information 60 is in a second substate of the second state, then at step 110 the processing circuitry 16 is controlled to perform both the first and second operations with a second ordering between the first and second operations different to the first ordering. The first and second orderings could differ in terms of whether the first and second operations are performed sequentially or in parallel, or in terms of which of the first and second operations is performed first and which is performed second. The orderings could also differ in terms of whether there is any dependency between the first and second operations (i.e. whether one operation depends on the result of the other or whether the two operations are independent).

Support for controlling the ordering between the first and second operations is optional, and in some examples steps 106 and 110 could be omitted so that when the instruction-function-selecting information is in the second state then the method proceeds to straight to step 108 to perform both the first and second operations with a first ordering selected by default.

Specific examples of controlling the ordering between operations are described below with respect to FIGS. 9 to 12.

If, at step 102, the instruction-function-selecting information 60 is in a third state, then at step 112 the processing circuitry 16 is controlled to perform the first operation but not the second operation.

If the instruction-function-selecting information is in a fourth state, then at step 114 the processing circuitry 16 is controlled to perform the second operation but not the first operation. Support for step 140 may be optional, and in some examples it may not be possible for the NOP-compatible instruction to perform the second operation but not the first operation. For example, in some use cases if there is only space for four different states of the instruction-function-selecting information (e.g. because only 2 bits are used for this information 60) then some implementations may prefer to use the fourth encoding of the instruction-function-selecting information 60 to allow for two different sub-states of the second state as shown in steps 108 and 110, so that the ordering of the operations could be controlled. Other examples may support all of the states and sub-states of FIG. 3 and so may use instruction-function-selecting information with 3 or more bits to allow these additional encodings of the instruction-function-selecting information.

One possible encoding of the instruction-function-selecting information (with no support for controlling ordering between the first and second operations) could be as follows:
0b00—first operation disabled, second operation disabled-instruction behaves as NOP (first state);
0b01—first operation enabled, second operation disabled (third state);
0b10—first operation disabled, second operation enabled (fourth state);
0b11—first operation enabled, second operation enabled (second state).
   Such an encoding may provide a separate bit for each operation independently indicating whether that operation is enabled or disabled. This could be extended to a third operation or further operations by providing additional bits per operation which each turn on/off any additional operation.

Another example encoding of the instruction-function-selecting information dispenses with the ability to perform the second operation without the first operation, but uses the fourth encoding of the instruction-function-selecting information 60 to indicate the desired ordering between the first and second operations when both operations are performed:
0b00—first operation disabled, second operation disabled—instruction behaves as NOP (first state);
0b01—first operation enabled, second operation disabled (third state);
0b10—first operation enabled, second operation enabled, first ordering between first and second operations (second state—first sub-state);
0b11—first operation enabled, second operation enabled, second ordering between first and second operations (second state—second sub-state).

Another example encoding could use more than 2 bits and leave some encodings spare for future use, e.g. in adding support for additional operations or configuration options:
0bX00—first operation disabled, second operation disabled-instruction behaves as NOP (first state);
0bX01—first operation enabled, second operation disabled (third state);
0bX10—first operation disabled, second operation enabled (fourth state);
0b011—first operation enabled, second operation enabled, first ordering between first and second operations (second state—first sub-state);
0b111—first operation enabled, second operation enabled, second ordering between first and second operations (second state—second sub-state).
   It will be appreciated that all of these examples are just some ways in which the operations to be performed for the NOP instruction could be encoded by the instruction-function-selecting information 60.

A wide variety of processing operations can be used as the first and second operations. However, one particular use case can be for function prologue or epilogue operations to be performed on a function call or function return respectively. In particular, it can be useful for the first and second operations to be alternative operations for protecting against return oriented programming (ROP) attacks on function return state. For example, the first and second operations can be pointer authentication/checking operations or GCS push/pop operations described further below.

FIG. 5 illustrates an example of calling a function (labelled fn1 for ease of reference) and returning from the function. A function (also known as a procedure) is a sequence of instructions that can be called from another part of a program and which when complete returns processing to the part of the program flow from which the function was called. The same function can be called from a number of different locations in the program, and so a function return address is stored on calling the function, so that the function return can distinguish which address program flow should be returned to.

For example, as shown in FIG. 5, a branch with link instruction BLR may be executed at the point (represented by address #add1) where the function is to be called, to cause program flow to branch to an instruction at a branch target address #add2 specified using operands of the branch with link instruction. The branch with link instruction also causes the processing circuitry to set a link register (a designated register used for tracking a function return address, e.g. general purpose register as shown above) to an address of the next instruction after the branch with link instruction (in this example, the function return address is #add1+4). After the branch has been taken, a number of instructions (e.g. LD, MUL, ADD, etc.) are executed within the function code and when the function is complete a return branch instruction RET is executed which causes a branch to the instruction indicated by the return address stored in the link register.

If no other functions are called from within fn1, and no exception occurs before the return branch at the end of fn1 is reached, then the address in the link register should still be the same as set when fn1 was called.

However, often a first function fn1 called by background code may itself call a further function (fn2, say) in a nested manner, and in this case the function call to fn2 would overwrite the return address stored in the link register, and so prior to calling that further function, the function code of the first function fn1 should include an instruction to save the return address from the link register to a data structure in memory (e.g. a stack structure, operated in a last-in-first-out (LIFO) manner), and after returning from fn2 the function code of fn1 should restore the return address to the link register before executing the return branch. The responsibility for saving and restoring function return state such as the return address would typically lie with the software (there may be no architecturally-enforced hardware mechanism for saving the return address).

However, while the function return address is stored in memory, it may be vulnerable to an attacker modifying that data, for example using another thread executing on another processor core, or by interrupting the called function and executing other code in the meantime which overwrites the return address stored in memory. Alternatively, the attacker could execute some instructions which aim to modify the address operands of the instruction which restores the return address from memory to a register, so that the data loaded from memory is not the same as the return address which was originally saved to memory before calling a nested function. If the attacker can cause the return branch to branch to a point in the program flow other than the instruction after the function calling branch, the attacker may be able to cause the software to behave incorrectly, and may be able to circumvent certain security protections or cause undesired operations to be performed.

A function call is one example of an operation which generates return state information providing information about the state to which the processing circuitry is to be restored at a later time. Another scenario when return state information may be captured may be when an exception is taken, at which point exception handling circuitry provided in hardware, or a software exception handler, may capture exception return state information, such as an exception return address indicating an address of an instruction to be executed after returning from handling an exception, and/or saved processor state information indicating a mode or execution state in which the processor is to execute after returning from the exception. For example, the saved processor state information could indicate which exception level the exception was taken from, as well as other information about the operating state of the processor at the time the exception was taken. As with function calls, exceptions may be nested and so exception return state captured for one exception can be saved to memory (either automatically in hardware, or by a software exception handler) when another exception is taken, and so may be vulnerable to tampering by an attacker while it is stored in memory. These types of attacks may be referred to as return oriented programming (ROP) attacks. It can be desirable to provide an architectural countermeasure against such attacks.

FIG. 6 illustrates an approach for protecting against ROP attacks using a protected data structure 120 in memory called a “guarded control stack” (GCS). The location of the GCS data structure within the memory address space may be selected by software, but the hardware provides architectural features designed to protect the GCS data structure against tampering by a malicious attacker.

As shown in FIG. 2, the registers 14 include control registers 56 including one or more guarded-control-stack-pointer (GCS pointer) registers 58 for storing a stack pointer indicating an address on the GCS data structure. In some examples, the GCS pointer register 58 may be a banked set of registers, provided separately for at least two execution states (e.g. exception levels), to enable software operating at different execution states to reference different GCS structures within memory without needing to reprogram a shared stack pointer register after each transition of execution state. Other examples could use a single GCS pointer register and software could update the stack pointer stored in the GCS pointer register 58 on a transition between execution states.

As shown in FIG. 6, the GCS data structure 120 is stored in a region of memory designated as being a GCS region of memory by a memory attribute specified, either directly or indirectly, by an associated page table entry of the page tables used by the memory management unit (MMU) 28 for controlling address translation and access permission checks. The GCS region attribute could be specified either directly within the encoding of the corresponding page table entry, or could be referenced indirectly within a register referenced by the page table entry.

When a memory region is identified as being the GCS region, then write access to that region is restricted to write requests triggered by the processing circuitry 16 when executing a certain subset of GCS-accessing instructions. General purpose store instructions used by software for general store operations not intended to access the GCS structure are not considered one of the restricted subset of GCS-accessing instructions. The MMU 28 may still permit the GCS structure to be read using a general purpose load instruction which causes issuing of a read request which is not a GCS memory access request. When a memory access request is requesting access to a GCS region, the request is a write request, and the request is not a GCS memory access request triggered by one of the restricted subset of GCS-accessing instructions, then the memory access request is rejected and the fault is signalled. The subset of GCS-accessing instructions may include at least a GCS push instruction which causes return state information (such as the function return address from the link register, or an exception return address or saved processor state captured on taking an exception) to be pushed to a location on the GCS structure determined using the stack pointer indicated in the GCS pointer register 58. GCS-accessing instructions may also include at least one form of GCS pop instruction which pops protected return information from the GCS structure.

Conversely, the GCS-accessing instructions may not be allowed to access memory regions which are not designated by the page table attributes as the GCS region type. Hence, a fault can be signalled if an attempt to perform a GCS access is made when the memory region targeted by the access is not marked as the GCS region type. By prohibiting use of GCS-accessing instructions for accessing non-GCS regions, this discourages programmers from using the GCS-accessing instructions unless it is really intended to be a GCS access, to reduce the attack surface available to an attacker

The GCS structure is separate from any data structure used by the software to maintain saved return state information within memory to handle nesting of function calls or exceptions. Hence, the GCS structure is not intended to eliminate the need for software itself to track saving and restoring of return state information when function calls or exceptions are nested (the software-triggered saving of return state may continue in the same way as on a processor not supporting the GCS-protected architectural measures discussed above). Instead, the GCS structure provides a region of protected memory which is protected against tampering by compromised program code, which can be used to provide information for verifying the return state information intended to be used by the software to return from processing of the function call or an exception.

In some implementations the GCS pop instruction, which causes protected return state information to be popped from the GCS structure, may also cause the processing circuitry 16 to compare the popped return state with current return state information stored in registers (e.g. the link register 54 for a function return, or an exception return address register and/or saved processor state register for an exception return), and to signal a fault if there is a mismatch between the return state information popped from the GCS structure 120 and the intended return state information which software intends to use for a function/exception return. Hence, software can be protected against tampering by including instances of the GCS push and GCS pop instruction within the program code to be executed around a function call/return or exception entry/return.

Other implementations may define a separate instruction for verifying whether the intended return state information is valid, separate from the instruction which pops return state information from the GCS structure 120.

Alternatively, the GCS pop instruction could pop the protected return state from the GCS directly to one or more registers used to specify the return state for an exception return or function return (or could be combined with the exception/function return instruction to both pop the protected return state and use that state for controlling an exception/function return), in which case it is not essential to carry out a step of verifying whether software-provided intended return state information is valid, as in such an implementation the GCS-protected return state is used directly to control the exception/function return. For example, for GCS protection of a function return address, the function return address could be popped directly to the link register 54 replacing any software-managed function return address that software may have placed there based on its own managed stack structure.

Also, other types of GCS accessing instructions could also be supported. Some instructions, which have other functions in a mode where use of the GCS is disabled, could cause the processing circuitry 16 to perform additional functions (such as additional GCS-mode-specific security checks) when executed when the GCS mode is enabled (control state in the control registers 56 may control whether the GCS mode is enabled).

In general, by providing architectural support for defining a GCS memory region type for use for the GCS structure 120, and restricting write access to the GCS region type to a limited subset of GCS accessing instructions (which may not be allowed to access memory regions other than the GCS region type), this reduces the attack surface available for an attacker to try to tamper with the protected return state information stored on the GCS structure 120.

The GCS provides one defence against ROP attacks. Another option for protecting against ROP attacks is use of authentication codes associated with the return state information. FIG. 7 illustrates an example of an authentication code generation operation performed in response to an authentication code generating instruction, based on a first source operand src1. The source operand can be any value but it is particularly useful to apply the authentication code generating operation to address pointers, such as a function return address. The source operand may specify (e.g. by reference to a source register such as the link register) an address which comprises a certain number of bits X, but in practice only a certain number Y of those bits may be used for valid addresses (e.g. X may equal 64 and Y may equal 48 or 52). Hence, X-Y upper bits of address may by default would be set to zero.

In the authentication code generating operation, the source operand may be passed to encryption/decryption circuitry of the processing circuitry 16 (e.g. the execute stage 16 may include an encryption/decryption function unit similar to the other execution units 20, 22, 24, 26 shown in FIG. 1), which may apply an authentication code generating function 140 to the first source value based on a cryptographic key read from cryptographic key storage and at least one modifier value. The resulting authentication code (PAC) is inserted into the unused upper bits of the pointer address, to generate the result of the instruction. The result may for example be written back to the same register which stored the source operand. For example, if executed with the source operand being the current function return address stored in the link register 54, the result is written back to the link register 54. The authentication code generating function 40 may use a cryptographic hash function (e.g. SHA256, SHA128, QARMA-128, QARMA-256, etc.) which makes it computationally infeasible to guess the authentication code associated with a particular address without knowledge of the cryptographic key. The modifier value may be a value used to tie the specific instance of the authentication code generated by the operation to a specific point of execution reached in the program code, reducing the risk of reuse attacks where a valid address/PAC pair from one part of the code is incorrectly substituted for use at another part of the code. For example, the stack pointer from the stack pointer register 52, or a call path indicator representative of a history of function calls taken to reach the current point of processing, could be used as the modifier.

FIG. 8 shows a corresponding authentication code checking operation which is performed on a second source operand src2. The second source operand is expected to be a pointer address which has previously been authenticated by inserting the authentication code PAC into its upper bits in the authentication code generating operation shown in FIG. 7, but if an attacker has modified the pointer, the authentication code (PAC) may not be valid. In the authentication code checking operation, the processing circuitry 16 applies the same authentication code generating function 140 to the address bits of the second source operand (excluding the authentication code PAC), using the corresponding cryptographic key and modifier values to those expected to have been used when the authentication code represented by the upper bits of the address was generated. The expected authentication code PAC′ is then compared with the associated authentication code PAC extracted from the upper bits of the second source operand src2 and it is determined whether the expected authentication code and associated authentication code match. If so, then processing is allowed to continue, while if there is a mismatch between the expected and associated codes then an error handling response is triggered, for example triggering an exception or setting the upper bits of the source register to a value which corresponds to an invalid address so that a subsequent access or instruction fetch to that address would trigger the MMU 28 to trigger a memory fault because of accessing an invalid address (this means that if the address having the incorrect PAC is used for a function return, a subsequent attempt to fetch an instruction from that address following the return branch would trigger a fault preventing the processing circuitry from continuing to execute the program beyond the incorrect function return).

By using the authentication code generating and checking operations of FIGS. 7 and 8, this allows pointers to be authenticated so that is more difficult for an attacker to inject an unauthorised pointer and successfully cause code to branch to a location identified by that pointer, protecting against ROP attacks. By using a cryptographic function as the authentication code generating function 140 this can make brute force guessing of the authentication code associated with a particular address difficult. An instruction for performing the authentication code generating operation can be included in the code at the point when a pointer address is generated (e.g. between setting the link register in response to a function call and saving the function return address from the link register to memory) and the authentication code checking instruction AUT can be included later when the address is actually to be used (e.g. before a function return branch), to double check the authentication code before actually branching to the address.

The authentication code generating function 140 may vary from implementation to implementation, or can be configurable on a given implementation based on control state in the control registers 56. The modifier value to be used for the authentication code generation function may also be configurable or may differ for different variants of instructions implementing the authentication code generating/checking operations.

Both the GCS operations and the authentication code operations described above with respect to FIGS. 6 to 8 can be seen as defences against ROP attacks, but some users may prefer to use one form of defence and others may use the other. Some users may prefer to use both in combination for a defence in depth approach. Also, it may be desirable for these operations sometimes to be omitted, in scenarios where a piece of code which is sometimes used in a use case requiring the security of the ROP defence could also be executed in use cases not requiring this security, in which case it may be better for performance to omit these operations. Therefore, these operations can be useful examples for the first and second operations of the NOP-compatible instruction described above.

In some cases, it may be desirable to provide a program binary which is both backwards compatible with old hardware not supporting the GCS and authentication code features, and supports new functionality when run on newer hardware supporting these features. Hence, the opcode 72 chosen for the NOP-compatible instruction may be one which on older hardware may be treated as a NOP instruction.

Normally, when a new architecture feature is added to an ISA, a control register may be used to indicate whether that feature is supported, and software may need to check whether the feature is implemented before using it. For many features this is acceptable, but for features which are expected to be executed extremely frequently, such as features used in function prologues and epilogues, this is not feasible for performance reasons. For such features, it can be useful to provide a set of NOP instruction encodings that perform no operation, at least until some functionality is added to that encoding for newer hardware supporting the updated architecture. As more features are added the architecture, more NOP-compatible instructions could be added in function prologues and epilogues corresponding to each additional feature, but this will make the functions much larger as more NOP-compatible instructions are added, incurring a cost in caching structures and instruction throughput and therefore diminishing performance.

Therefore, with the NOP-compatible instruction described above, multiple operations can be overloaded onto a single NOP-compatible encoding, with the instruction-function-selecting information 60 in one or more control registers 56 provided to turn on/off each feature independently.

For example, as discussed above, for the Guarded Control Stack feature, for which we want to push the contents of the link register (e.g. a function return address) to a protected stack on function entry, and the authentication code generating operation (PAC feature) mentioned above to sign a pointer such as the function return address, this would normally involve two instructions, to perform the GCS push operation (GCSPUSH) and the signing operation (PACIASP). Similarly, on the function return there would be corresponding instructions to perform the GCS pop operation (GCSPOP) and the authentication code checking operation (AUTIASP).

```
myfunc( ):
  PACIASP LR
  GCSPUSH LR
  ... // my function contents
  GCSPOP LR
  AUTIASP LR
  RET
```

In contrast, by using the NOP-compatible instruction described above to provide both pieces of functionality, this allows us to have a smaller function, and also for it to work on old and new hardware (as old hardware can treat it as a NOP, and even on newer hardware there is the configuration option of disabling both operations by setting the instruction-function-selecting information to the first state).

For example, if a combined instruction (in this example, assumed to have the PACIASP encoding) performs all the operations, we can have a smaller function:

```
myfunc( ):
  PACIASP LR // also performs GCSPUSH
  ... // my function contents
  AUTIASP LR // also performs GCSPOP
  RET
```

Note that AUTIASP is the complement of PACIASP, and in the above example is also the complement of GCSPUSH, by performing the GCSPOP operation.

For example, we can provide 2 control bits to govern the behaviour of these encodings
00—PAC disabled, GCS disabled
01—PAC enabled, GCS disabled
10—PAC disabled, GCS enabled
11—PAC enabled, GCS enabled

This can be extended in the future with new features, adding control bits to turn off/on the functionality, all performed by the single encoding. Also, it would be possible for the control state to control the relative ordering with which the operations are performed.

Hence, multiple new features can be turned on and off for the same instruction encoding, without rebuilding the program binary.

The example above shows a case where the first and second operations are either:
for a function prologue variant, the GCS push operation and authentication code generating operation respectively, or vice versa; or
for a function epilogue variant, the GCS pop operation and authentication code checking operation respectively, or vice versa.
   Both variants can be supported in the same ISA, with different encodings of the opcode field 72 for the function prologue variant and the function epilogue variant respectively.

However, in other examples, it would also be possible to provide a NOP-compatible instruction which combines the GCS push operation with another kind of operation other than the authentication code generating operation, or which combines the authentication code generating operation with another kind of operation other than the GCS push operation. Similarly, it would be possible to provide a NOP-compatible instruction which combines the GCS pop operation with another kind of operation other than the authentication code checking operation, or which combines the authentication code checking operation with another kind of operation other than the GCS pop operation.

FIGS. 9 to 12 show different examples of controlling the ordering between the PAC/AUT and GCS operations in cases where both operations are performed in response to the NOP-compatible instruction.

FIG. 9 shows an example where the NOP-compatible instruction (executed as a function prologue) performs both the authentication code generating operation (PAC) and the GCS push operation, with the GCS push operation being dependent on the result of the authentication code generating operation so that both the function return address and its associated authentication code are pushed to the GCS. In other words, this is equivalent to performing the PAC operation and then the GCS push operation sequentially with the destination register of the PAC operation being the same as the source register for the GCS push operation. In contrast, FIG. 10 shows performing the PAC and GCS push operations in a different ordering, where the GCS push operation is independent of the PAC operation. This allows the push of the function return address to the GCS structure to be started in parallel with the calculation of the authentication code by the PAC operation. This can be useful since both the PAC generating function 140 and the memory access for the GCS push operation may be relatively slow, and so parallelising these operations can have improved performance compared to the ordering of FIG. 9. On the other hand, the example of FIG. 9 may have improved security because the generated authentication code is protected on the GCS, not just the function return address.

Similarly, FIGS. 11 and 12 show alternative orderings for an example where the NOP—compatible instruction (executed as a function epilogue) implements, as the first and second operations, the GCS pop operation and authentication code checking (AUT) operation (either way round—the first operation could be the GCS pop operation and the second operation could be the AUT operation, or vice versa). FIG. 11 shows an ordering where the AUT operation is dependent on the result of the GCS pop operation, since the value popped from the GCS by the GCS pop operation is used as the input for the AUT operation. This approach can be used in an example where the corresponding NOP-compatible instruction executed as a function prologue used the approach shown in FIG. 9. Again, this has the advantage of greater security since the authentication code is protected against tampering using the GCS memory region protections implemented by the MMU 28. On the other hand, FIG. 12 shows an ordering where the AUT operation and GCS pop operation are independent so that they can both be started in parallel. In this case, the authentication code checking may be applied to the value in the link register and then separately the GCS pop operation may also pop a value (not having an associated authentication code) to a destination register. Assuming the old value in the link register is read for the AUT operation before the value popped from the GCS structure is returned from memory, the destination register for the GCS pop operation could still be the same register as used for the source operand for the AUT operation—in that case if the AUT operation detects a mismatch then a fault or other error response action is taken, and if the codes match, the GCS pop operation is allowed to complete and then the address popped by the GCS pop operation could be used for a function return. Alternatively, the GCS pop operation could pop the protected return address from the GCS structure in memory to a register other than the one checked by the AUT operation, and then subsequently a comparison between the value checked by the AUT operation and the value popped from the GCS structure could be made, to confirm whether the GCS protected address matches the AUT-checked address, providing a further check of whether it is safe to proceed with a function return based on the address.

Hence, it can be useful for the instruction decoder 10 and execute stage 16 to support:
for use in a function prologue, a first NOP-compatible instruction, for which one of the first/second operations is the authentication code generating operation (PAC) and the other of the first/second operations is the GCS push operation; and
for use in a function epilogue, a second NOP-compatible instruction (having a different encoding to the first NOP-compatible instruction), for which one of the first/second operations is the authentication code checking operation (AUT) and the other of the first/second operations is the GCS pop operation.
   The instruction-function-selecting information 60 may specify which of the first and second operations (if any) is to be performed in response the instruction and may also control the relative ordering of the operations as shown in FIGS. 9 to 12.

FIG. 13 is a flow diagram showing steps performed by the MMU 28 for checking memory access permissions for memory access requests. At step 200 an instruction which triggers a load/store operation is decoded. The NOP-compatible instructions described above which supports a GCS push or pop operation is regarded as a load/store instruction if the instruction-function-selecting information 60 specifies that the GCS push or pop operation is to be performed.

At step 202 it is determined whether the instruction which triggers the load/store operation is a GCS accessing instruction (one of the restricted subset of GCS accessing instructions allowed to access GCS regions of memory as mentioned earlier). The NOP-compatible instruction is treated as a GCS accessing instruction when the instruction-function-selecting information indicates that the GCS push or pop operation is required. Other types of instruction could also be treated as a GCS accessing instruction. In some cases, the NOP-compatible instruction is not treated as the GCS accessing instruction if the instruction-function-selecting information is in a state which indicates that the GCS push or pop operation is not required. Alternatively, if the GCS push or pop operation is the only operation capable of generating load/store operations in response to the NOP-compatible instruction (e.g. the PAC/AUT operations described above may not generate any load/store requests), then the NOP-compatible instruction can always be treated as a GCS accessing instruction regardless of the value of the instruction-function-selecting information 60.

If the decoded instruction is a GCS accessing instruction, then at step 204 the MMU 28 checks whether the memory attribute data corresponding to the target address being accessed for the load/store operation specifies that a memory address space region corresponding to the target address is a GCS region. This memory attribute data could be derived from a page table entry corresponding to the target address or an indirection register specified by that page table entry (and may be cached in a translation lookaside buffer (TLB) of the MMU 28). If the instruction is a GCS accessing instruction but the memory attribute data specifies that the region corresponding to the target address is not a GCS region, then at step 206 the load/store operation is rejected, and a fault is signalled. This prevents GCS accessing instructions being used to access non-GCS memory, which can be safer for reducing the attack surface available to an attacker. Otherwise, if the GCS accessing instruction is accessing a GCS region, then at step 212 the MMU 28 checks whether any other access permission checks are passed by the load/store operation. If these other checks fail, then at step 214 the load/store operation is rejected, and a fault is signalled. If these other checks are passed, then at step 216 the load/store operation is allowed. These other checks could, for example, check read/write permissions which indicate whether reads or writes to the memory region are permitted, or could check other security attributes not related to the GCS region checking (e.g. attributes restricting the execution state of the processor in which the memory region is allowed to be accessed).

If the instruction which triggered the load/store operation is not a GCS accessing instruction, then at step 208 the MMU 28 checks whether the memory attribute data corresponding to the target address being accessed for the load/store operation specifies that a memory address space region corresponding to the target address is a GCS region. However, in this case the response is reversed compared to step 204—the load/store request can potentially be accepted if the non-GCS accessing instruction does not access a GCS region, while can be rejected if it accesses a GCS region. More specifically, if the memory attribute data for the region corresponding to the target address specifies a GCS region, then at step 205 the MMU checks whether the memory access is a write memory access and if so rejects the load/store operation at step 210, and signals a fault. By restricting write access to the GCS region to a dedicated class of GCS accessing instructions, this prevents the majority of regular store instructions in the program code from tampering with the protected return state on the GCS data structure. This reduces the opportunity for an attacker to modify the operands of a regular store instruction in an attempt to corrupt the protected return state on the GCS.

On the other hand, if the non-GCS-accessing instruction is not trying to access a GCS region (N at step 208) or is trying to access a GCS region but is a read request (N at step 205), then the method proceeds again to step 212 to apply any other access permission checks and then controls whether the load/store operation is rejected or allowed depending on the outcome of these checks, the same as discussed above for steps 212, 214, 216.

FIG. 14 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 1330, optionally running a host operating system 1320, supporting the simulator program 1310. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 1330), some simulated embodiments may make use of the host hardware, where suitable.

The simulator program 1310 may be stored on a computer-readable storage medium (which may be a non-transitory medium), and provides a program interface (instruction execution environment) to the target code 1300 (which may include applications, operating systems and a hypervisor) which is the same as the interface of the hardware architecture being modelled by the simulator program 1310. Thus, the program instructions of the target code 1300, including the NOP-compatible instruction described above, may be executed from within the instruction execution environment using the simulator program 1310, so that a host computer 1330 which does not actually have the hardware features of the apparatus 2 discussed above can emulate these features. Similarly, the memory management checking functions of FIG. 13 may be emulated using memory management program logic 1318 of the simulator program 1310.

Hence, the simulator program 1310 may have processing program logic 1312 which simulates the state of the processing described above for the hardware apparatus 2. For example the processing program logic 1312 may control transitions of execution state (e.g. exception level) in response to events occurring during simulated execution of the target code 1300. Instruction decoding program logic 1314 emulates the behaviour of the instruction decoder 10, and decodes instructions of the target code 1300 and maps these to corresponding sets of instructions in the native instruction set of the host apparatus 1330. Register emulating program logic 1316 maps register accesses requested by the target code to accesses to corresponding data structures maintained on the host hardware of the host apparatus 1330, such as by accessing data in registers or memory 1332 of the host apparatus 1330. Memory management program logic 1318 implements address translation, page table walks and access control checking in a corresponding way to the MMU 28 described in the hardware-implemented embodiment above, but also has the additional function of mapping the simulated physical addresses, obtained by the address translation based on the page tables defined for the target code 1300, to host virtual addresses used to access host memory 1332. These host virtual addresses may themselves be translated into host physical addresses using the standard address translation mechanisms supported by the host (the translation of host virtual addresses to host physical addresses being outside the scope of what is controlled by the simulator program 1310).

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
an instruction decoder to decode instructions;
processing circuitry to perform data processing in response to decoding of the instructions by the instruction decoder; and
at least one control register to specify instruction-function-selecting information;
in which:
in response to a no-operation-compatible instruction, the instruction decoder is configured to control the processing circuitry to:
treat the no-operation-compatible instruction as a no-operation instruction, when the instruction-function-selecting information specified by the at least one control register is in a first state;
perform both a first operation and a second operation, when the instruction-function-selecting information specified by the at least one control register is in a second state; and
perform the first operation but not the second operation, when the instruction-function-selecting information specified by the at least one control register is in a third state.

2. The apparatus according to claim 1, in which, in response to the no-operation-compatible instruction, the instruction decoder is configured to control the processing circuitry to perform the second operation but not the first operation, when the instruction-function-selecting information is in a fourth state.

3. The apparatus according to claim 1, in which, when the instruction-function-selecting information is in the second state, the processing circuitry is configured to control, based on the instruction-function-selecting information, a relative order in which the first operation and the second operation are applied.

4. The apparatus according to claim 1, in which the first operation and the second operation are function prologue operations associated with a function call; or
the first operation and the second operation are function epilogue operations associated with a return from processing of a function.

5. The apparatus according to claim 1, in which for at least one variant of the no-operation-compatible instruction, one of the first operation and the second operation comprises an authentication code generating operation to generate an authentication code based on an operand and associate the authentication code with the operand.

6. The apparatus according to claim 5, in which the operand comprises a value obtained from a link register; and
in response to a function return branch instruction, the instruction decoder is configured to control the processing circuitry to branch to an address specified in the link register.

7. The apparatus according to claim 5, in which associating the authentication code with the operand comprises embedding the authentication code in a portion of more significant bits of the operand.

8. The apparatus according to claim 5, in which the authentication code generating operation comprises generating the authentication code according to a cryptographic function based at least on the operand and a cryptographic key.

9. The apparatus according to claim 1, in which for at least one variant of the no-operation-compatible instruction, one of the first operation and the second operation comprises a guarded-control-stack (GCS) push operation to push the operand to a GCS data structure for protecting return state information.

10. The apparatus according to claim 1, in which:
for at least one variant of the no-operation-compatible instruction:
one of the first operation and the second operation comprises an authentication code generating operation to generate an authentication code based on an operand and associate the authentication code with the operand;
the other of the first operation and the second operation comprises a guarded-control-stack (GCS) push operation to push the operand to a GCS data structure for protecting return state information.

11. The apparatus according to claim 10, in which:
in response to the no-operation-compatible instruction when the instruction-function-selecting information is in a first sub-state of the second state, the processing circuitry is configured to push the operand and the authentication code to the GCS data structure; and
in response to the no-operation-compatible instruction when the instruction-function-selecting information is in a second sub-state of the second state, the processing circuitry is configured to push the operand without the authentication code to the GCS data structure.

12. The apparatus according to claim 1, in which for at least one variant of the no-operation-compatible instruction:
one of the first operation and the second operation comprises an authentication code checking operation to check whether an associated authentication code associated with an operand matches an expected authentication code generated based on the operand, and to trigger an error handling response in response to detecting a mismatch between the associated authentication code and the expected authentication code.

13. The apparatus according to claim 12, in which the associated authentication code is obtained from a portion of more significant bits of the operand.

14. The apparatus according to claim 1, in which for at least one variant of the no-operation-compatible instruction, one of the first operation and the second operation comprises a guarded-control-stack (GCS) pop operation to pop function return information from a GCS data structure for protecting the function return information.

15. The apparatus according to claim 1, in which, for at least one variant of the no-operation-compatible instruction:
one of the first operation and the second operation comprises an authentication code checking operation to check whether an associated authentication code associated with an operand matches an expected authentication code generated based on the operand, and to trigger an error handling response in response to detecting a mismatch between the associated authentication code and the expected authentication code; and
the other of the first operation and the second operation comprises a guarded-control-stack (GCS) pop operation to pop function return information from a GCS data structure for protecting the function return information.

16. The apparatus according to claim 15, in which:
in response to the no-operation-compatible instruction when the instruction-function-selecting information is in a first sub-state of the second state, the processing circuitry is configured to perform the GCS pop operation and perform the authentication code checking operation on a value popped from the GCS data structure by the GCS pop operation; and
in response to the no-operation-compatible instruction when the instruction-function-selecting information being in a second sub-state of the second state, the processing circuitry is configured to perform the authentication code checking operation on a value in a given register prior to performing the GCS pop operation, and perform the GCS pop operation to pop the function return information from the GCS data structure to the given register.

17. The apparatus according to claim 9, in which:
in response to the no-operation-compatible instruction, when the instruction-function-selecting information is in a state indicating that an access to the GCS data structure is to be performed in response to the no-operation-compatible instruction:
the processing circuitry is configured to reject a memory access triggered by the non-operation-compatible instruction in response to detecting that a memory region corresponding to a target address of the no-operation-compatible instruction is specified by memory attribute data as being a memory region other than a GCS region for storing the GCS data structure.

18. The apparatus according to claim 17, in which the processing circuitry is configured to reject a write memory access triggered by a non-GCS-accessing type of instruction in response to detecting that a memory region corresponding to a target address of the non-GCS-accessing type of instruction is specified by memory attribute data as being the GCS region.

19. The apparatus according to claim 1, in which the instruction-function-selecting information comprises a first operation indicator to indicate whether or not the first operation is to be performed in response to the no-operation-compatible instruction, and a second operation indicator to indicate whether or not the second operation is to be performed in response to the no-operation-compatible instruction.

20. The apparatus according to claim 1, in which the instruction-function-selecting information further indicates whether the processing circuitry should perform a third operation in response to the no-operation-compatible instruction.

21. A method comprising:
decoding instructions; and
performing data processing in response to decoding of the instructions; in which:
in response to decoding of a no-operation-compatible instruction, the method comprises:
treating the no-operation-compatible instruction as a no-operation instruction, when instruction-function-selecting information specified by at least one control register is in a first state;
performing both a first operation and a second operation, when the instruction-function-selecting information specified by the at least one control register is in a second state; and
performing the first operation but not the second operation, when the instruction-function-selecting information specified by the at least one control register is in a third state.

22. A non-transitory storage medium storing a computer program comprising instructions which, when executed by a host data processing apparatus, control the host data processing apparatus to provide an instruction execution environment for executing target code, the computer program comprising:
instruction decoding program logic to decode instructions of the target code; and
register emulating program logic to maintain data in storage circuitry of the host data processing apparatus to emulate at least one control register for specifying instruction-function-selecting information; in which:
in response to a no-operation-compatible instruction, the instruction decoding program logic is configured to control the host data processing apparatus to:
treat the no-operation-compatible instruction as a no-operation instruction, when the instruction-function-selecting information is in a first state;
perform both a first operation and a second operation, when the instruction-function-selecting information is in a second state; and
perform the first operation but not the second operation, when the instruction-function-selecting information is in a third state.

23. (canceled)
